(19) United States
(12) Patent Application Publication
(10) Pub. No.: US 2021/0278224 A1
(43) Pub. Date: Sep. 9, 2021

(54) COORDINATING TRIPS BY VEHICLES IN AN ON-DEMAND ENVIRONMENT

(71) Applicant: QUALCOMM Incorporated, San Diego, CA (US)

(72) Inventors: Jonathan Paul DAVIS, Philadelphia, PA (US); Michael Franco TAVEIRA, Rancho Santa Fe, CA (US)

(21) Appl. No.: 16/808,062

(22) Filed: Mar. 3, 2020

(51) Int. Cl. G01C 21/34; G06Q 10/06

(52) U.S. Cl. CPC G01C 21/3407; G05D 1/0088; G06Q 10/06311

(57) ABSTRACT

Certain aspects of the present disclosure provide techniques for coordinating trips for multiple users in an autonomous vehicle system. An example method generally includes receiving, from a first user, information identifying a destination of a trip to be performed by an autonomous vehicle. The identified destination is broadcast to one or more second users. Information about one or more additional destinations to be visited by the autonomous vehicle is received from the one or more second users, and a trip routing is generated. The trip routing generally includes the identified destination and the one or more additional destinations.

### INTRODUCTION

Aspects of the present disclosure relate to scheduling and coordinating trips performed by vehicles in an on-demand environment.

Autonomous vehicles are generally vehicles that are capable of driving with limited to no human input. These vehicles may range from vehicles that are capable of driving from a starting location to a destination while expecting human intervention in some scenarios (e.g., in scenarios for which an autonomous vehicle has not been trained to respond) to vehicles that are fully automated and do not include controls for a driver to use in controlling the vehicle. Generally, to allow for autonomous driving, autonomous vehicles may include various computers, sensors, controllers, and the like that allow the vehicle to recognize signs and obstacles, control various vehicle subsystems, communicate with other vehicles, and the like.

In an on-demand environment, users of vehicles—both human-driven and autonomous—can request rides to one or more specified destinations on a scheduled basis or on demand. For example, in a ride hailing application, a vehicle can be dispatched to meet a rider at an origin location and deliver the rider to a specified destination. However, given a fleet of a limited number of vehicles, the number of trips that may be performed by the fleet may be limited by the number of vehicles in the fleet. Further limitations may be imposed by an amount of energy remaining on each vehicle in the fleet, given assumed power requirements for the vehicle to reach a charging or refueling station (which includes the power needed to propel the vehicle, run electrical components in the vehicle, such as lighting, sound, and ventilation, and run the computers and sensors that process inputs and allow for autonomous driving). For example, the number of available vehicles in a fleet of electric vehicles may exclude vehicles that are traveling to a charging point or are at a charging point. These excluded vehicles may be excluded for a period of time commensurate with the amount of time needed to charge the batteries of these vehicles to a sufficient level.

Accordingly, what is needed are systems and methods for optimizing usage of vehicles that can be used to perform trips in an on-demand environment.

### BRIEF SUMMARY

Certain embodiments pr method for coordinating trips for multiple users in an autonomous vehicle system. The method generally includes receiving, from a first user, information identifying a destination of a trip to be performed by an autonomous vehicle. The identified destination is broadcast to one or more second users. Information about one or more additional destinations to be visited by the autonomous vehicle is received from the one or more second users, and a trip routing is generated. The trip routing generally includes the identified destination and the one or more additional destinations.

Further embodiments of the present disclosure provide a system having a processor and a memory. The memory generally includes instructions stored thereon which, when executed by the processor, performs an operation for coordinating trips for multiple users in an autonomous vehicle system. The operation generally includes receiving, from a first user, information identifying a destination of a trip to be performed by an autonomous vehicle. The identified destination is broadcast to one or more second users. Information about one or more additional destinations to be visited by the autonomous vehicle is received from the one or more second users, and a trip routing is generated. The trip routing generally includes the identified destination and the one or more additional destinations.

Still further embodiments of the present disclosure provide a computer-readable medium having instructions stored thereon which, when executed by a processor, performs an operation for coordinating trips for multiple users in an autonomous vehicle system. The operation generally includes receiving, from a first user, information identifying a destination of a trip to be performed by an autonomous vehicle. The identified destination is broadcast to one or more second users. Information about one or more additional destinations to be visited by the autonomous vehicle is received from the one or more second users, and a trip routing is generated. The trip routing generally includes the identified destination and the one or more additional destinations.

Further embodiments relate to apparatuses configured to perform the methods described herein as well as non-transitory computer-readable mediums comprising computer-executable instructions that, when executed by a processor of a device, cause the device to perform the methods described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 illustrates an example system for coordinating trips made by a vehicle in an on-demand environment.

FIG. 2 illustrates an example user interface for coordinating requests for using a vehicle in an on-demand environment.

FIG. 3 illustrates an example user interface displaying coordinated requests to a user of a vehicle in an on-demand environment.

FIG. 4 example operations for coordinating trips among multiple users of a vehicle in an on-demand environment, according to embodiments described herein.

FIG. 5 illustrates example messages exchanged between user devices and a vehicle scheduler to coordinate trips among multiple users of a vehicle in an on-demand environment, according to embodiments described herein.

FIG. 6 illustrates example operations for coordinating trips among multiple users of a vehicle in an on-demand environment based on items to retrieve during a trip, according to embodiments described herein.

FIG. 7 illustrates example messages exchanged between user devices and an autonomous vehicle scheduler to coordinate trips among multiple users of a vehicle in an on-demand environment based on items to retrieve during a trip, according to embodiments described herein.

FIG. 8 illustrates example operations for identifying information about users of vehicles in an on-demand environment based on a destination of a vehicle, according to embodiments described herein.

FIG. 9 illustrates example messages exchanged between a user device and vehicles in an on-demand environment for identifying information about users of vehicles based on a destination of an autonomous vehicle, according to embodiments described herein.

FIG. 10 illustrates an example implementation of a processing system on which embodiments described herein may be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for coordinating trips performed by vehicles in an on-demand environment, such as vehicles used by drivers in a ride sharing network or autonomous vehicles.

Fleets of vehicles can provide for mobility as a service, where users are able to request a vehicle to take the user to a specified destination on demand or according to a specified schedule. While vehicles can be used to take individual users to a specified location, it may not be efficient for individual users to be conveyed to the same location using individual vehicles. Further, there may be situations where trips or tasks can be consolidated. For example, suppose a first user is going to a first destination, and a second user is going to a second destination that is on a route from a current location of the first user to the first destination. An efficient trip may consolidate the first user's trip to the first destination and the second user's trip to the second destination, which may allow a vehicle to more efficiently serve more users.

Example System for Coordinating Trips By Vehicles In An On-Demand Environment

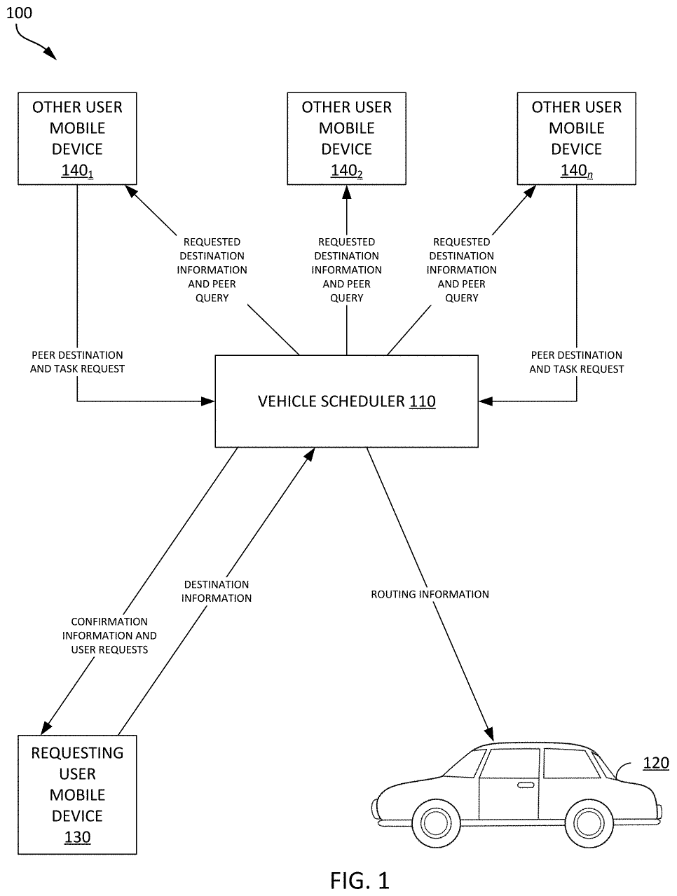

FIG. 1 illustrates an example system 100 in which trips for multiple users of an autonomous vehicle are scheduled. As illustrated, system 100 includes a vehicle scheduler, a vehicle 120, a requesting user mobile device 130, and a plurality of other user mobile devices 140₁-140n.

Vehicle scheduler 110 generally receives requests from a first user (e.g., via requesting user mobile device 130 and/or vehicle 120) to initiate a trip to a specified destination and broadcasts information about the trip to one or more other user mobile devices 140₁-140n to allow users of other user mobile devices 140₁-140n to request coordination of a trip with the trip made by the first user. While vehicle scheduler 110 and vehicle 120 are illustrated in FIG. 1 separately, it should be recognized that the vehicle scheduler 110 may be part of or integrated with vehicle 120.

As illustrated, vehicle scheduler 110 receives destination information from the requesting user mobile device 130. It should be recognized, however, that while FIG. 1 illustrates the transmission of a request by a requesting user mobile device 130, a request may be received directly from a vehicle 120 (e.g., where vehicle 120 is an autonomous vehicle that allows for user input of a requested destination). In some embodiments, vehicle scheduler 110 may receive this information in a request for a vehicle to perform a trip to a specified destination on-demand or in a request to schedule a trip from a specified origin location to a specified destination.

In some embodiments, vehicle scheduler 110 may receive information about one or more tasks to perform. For example, a user may provide a list of items to retrieve from one or more stores, and vehicle scheduler 110 can use the contents of the list to identify one or more stores to select as a destination. To do so, vehicle scheduler 110 can, in some embodiments, request inventory information for each of the specified items from inventory systems at one or more stores located a threshold distance away from the first user. Based on the returned inventory information, vehicle scheduler 110 can identify a minimal set of destinations to visit in order for the user to retrieve the specified items.

Vehicle scheduler 110 may then broadcast, to other user mobile devices 140₁-140ₙ the requested destination(s) of the first user. The broadcast may include a peer query requesting the users of other user mobile devices 140₁-140, to specify whether they would like to coordinate a trip with the first user. Vehicle scheduler 110 may select the other user mobile devices 140₁-140ₙ to which the requested destination and peer query is broadcasted on a variety of parameters. For example, the other user mobile devices 140₁-140ₙ may be selected from a list of the first user's friends in a social network. In some embodiments, the list of the first user's friends may be reduced based on current location information associated with each user in the list of the first user's friends. For example, assume that the first user is located in a first country, and one or the user's friends is currently located in a different country. Because it is unlikely that the friend located in a different country would coordinate a trip with the first user, vehicle scheduler 110 may omit the friend's mobile device 140 from the set of mobile devices to which a notification is transmitted. In another example, the other user mobile devices 140₁-140ₙ may be selected based on a proximity of the other user mobile devices 140₁-140ₙ to the current location of the first user and/or the identified destination. In still another example, the other user mobile devices 140₁-140ₙ may be selected based on a proximity of the other user mobile devices 140₁-140ₙ to a route between the current location of the first user to the identified destination.

In some embodiments, vehicle scheduler 110 may include a cutoff time for users of the other user mobile devices 140₁-140, to submit their requests to coordinate trips or tasks with the first user. The cutoff time may be, for example, based on a projected amount of time needed for a vehicle to reach the first user, a projected amount of time needed for the vehicle to reach the identified destination, and the like. For example, in a scenario where vehicle scheduler 110 coordinates trips to one or more destinations, the cutoff time may be the projected amount of time needed for the vehicle to reach the current location of the first user, plus an optional padding amount of time to account for the first user finding the vehicle, loading items into the vehicle, and/or other delays between the vehicle arriving at the current location of the first user and beginning a trip to the identified destination. In a scenario where vehicle scheduler 110 coordinates retrieval of items from one or more stores, the cutoff time may be the projected arrival time of the first user at the identified destination.

Vehicle scheduler 110 may receive a peer destination and task request from one or more of the other user mobile devices 140 (e.g., as illustrated, other user mobile devices 140₁ and 140ₙ). The peer destination and task request information received from the other user mobile devices 140₁-140ₙ may, in some embodiments, include a timestamp. If the timestamp included in information received from one of the other user mobile devices 140₁-140ₙ is after a cutoff time, the request may be dropped or coordinated with a request made by a different user. Otherwise, the request may be accepted. When vehicle scheduler 110 accepts a request, vehicle scheduler 110 can add the peer destination(s) to a list of destinations to visit during the trip and generate a route based on the list of destinations. The generated route may be generated such that the shortest distance is traversed to reach each destination in the list of destinations, such that the trip may be completed in the shortest estimated time, and the like. In some embodiments, requests may be accepted from up to a threshold number of users, which may be defined by the first user. After the threshold number of requests have been accepted and coordinated with the request made by the first user, additional requests may be coordinated with other users, and the users who generated these additional requests may be notified that their requests are being coordinated with a different user's request.

In some embodiments, the first user may respond to users associated with the accepted requests with additional information about the accepted requests. For example, the first user may indicate to a second user that the second user's request will be fulfilled by delivery to a specified location. The indication may include information about a projected time at which the second user's request will be fulfilled. In another example, the first user may indicate to the second user that items included the second user's request will be available for pick up at a specified location (e.g., at a location associated with the first user, such as the first user's home or work address) and at a specified time.

In some embodiments, vehicle scheduler 110 may aggregate task requests received from the other user mobile devices 140₁-140ₙ. After the cutoff time has been reached, the aggregated task requests may be provided to the requesting user mobile device 130 to indicate, to the first user, additional tasks to be performed on the trip to the identified destination. The additional tasks may include tasks to be performed at the identified destination (e.g., to retrieve items for a friend from the same store), tasks to be performed at locations near the identified destination, and/or tasks to be performed while the first user is en route to the identified destination. The aggregated task requests may be provided to the requesting user mobile device 130, in some embodiments, in a confirmation message indicating that the trip request was accepted and identifying the vehicle 120 that will be used to satisfy the trip.

In some embodiments, vehicle scheduler 110 can use the specified destination in the request to initiate the trip made by the first user to identify a set of other users who the first user may meet while at the specified destination. To do so, vehicle scheduler 110 can identify a projected time at which the vehicle will arrive at the specified destination. Based on the projected time of arrival and the specified destination, vehicle scheduler 110 can use information broadcast by one or more other vehicles 120 to identify users who will be at or near the specified destination at the projected time of arrival. In some embodiments, vehicle scheduler 110 can use various assumptions to include or exclude users from the set of other users. For example, users who have arrived at or near the specified destination more than a threshold amount of time prior to the projected arrival time may be excluded from the set of other users based on an assumption that those users may be leaving for other destinations at or around the projected arrival time of the first user. Users who are projected to arrive at the specified destination within a threshold amount of time from the projected arrival time of the first user may be included in the set of other users. Vehicle scheduler 110 may output the set of other users, along with the destinations of each of the users in the set of other users, to requesting user mobile device 130 for display to the first user. The first user can then adjust the selected destination based on the destinations identified for each user in the set of other users.

Example User Interfaces for Coordinating Trips By Vehicles In An On-Demand Environment

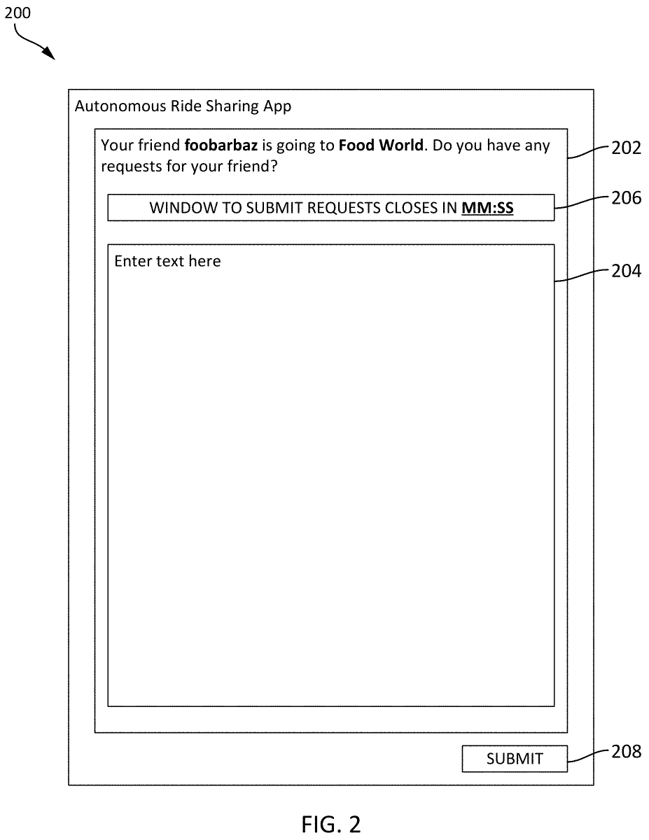

FIG. 2 illustrates an example user interface 200 of a ride sharing application that may execute on a mobile device (e.g., other user mobile devices 140₁-140ₙ illustrated in FIG. 1) to generate requests to coordinate trip requests with a trip made by a first user of a vehicle in an on-demand environment. The vehicles in the on-demand environment, as discussed, may be human operated vehicles in a traditional ride-sharing platform or autonomous vehicles that can operate without human intervention.

As illustrated, user interface 200 includes a prompt panel 202, user request entry panel 204, cutoff time indicator 206, and submit button 208. Prompt panel 202 may include information about the first user and the specified destination of the first user. For example, as illustrated, the first user is a user with the name “foobarbaz”, and the specified destination of the first user is “Food World”. This information may be retrieved from a request generated by a first user to use a vehicle to go to the specified destination and transmitted to a vehicle scheduler (e.g., vehicle scheduler 110 illustrated in FIG. 1) or directly to a vehicle (e.g., vehicle 120 illustrated in FIG. 1). In some embodiments, prompt panel 202 may include additional information that a user can use to determine whether to request coordination of a trip with the first user. For example, prompt panel 202 may include a map display showing the location of the first user and the location of the specified destination so that a user can see the general area in which the vehicle will be operating.

User request entry panel 204 generally allows a user to specify an additional destination or task to be coordinated with the first user. In some embodiments, user request entry panel 204 may allow for unstructured text entry, and the text may be parsed using various natural language recognition techniques to recognize destinations and tasks to be coordinated. In some embodiments, user request entry panel may include one or more controls to specify another destination to add to the trip between the first user's current location and specified destination (e.g., using a map control, address entry, etc.). After a user specifies an additional destination or additional tasks to be performed, the user can interact with submit button 208 to submit the request to a vehicle scheduler 110 for consolidation with the trip request made by the first user.

In some embodiments, cutoff time indicator 206 may indicate a time at which requests to coordinate trips are to be submitted in order to be consolidated with the first user's trip to the specified destination. As discussed, cutoff time indicator 206 may be based on a projected time at which the first user is to arrive at the specified destination, a projected time at which the vehicle will arrive at a pickup location for the first user, or the like. When the specified time in the cutoff time indicator is reached, user interface 200 may reload the content displayed in user interface 200 with information about a trip scheduled by a different user with which other trips may be consolidated.

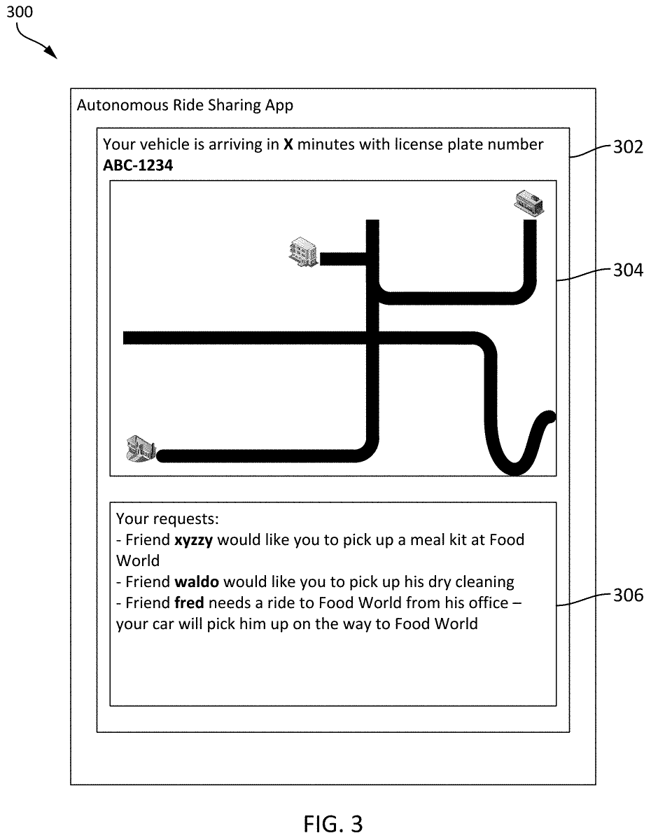

FIG. 3 illustrates an example user interface 300 of a ride sharing application that may execute on a mobile device (e.g., requesting user mobile device 130 illustrated in FIG. 1) to inform a user of any other trips or tasks consolidate with the first user's trip to a specified destination using a vehicle in an on-demand environment.

As illustrated, user interface 300 includes a status panel 302, a map panel 304, and a request panel 306. Status panel 302 generally may include information about the vehicle that has been dispatched to serve the first user. For example, if the first user has requested that a vehicle pick the user up at a specified location, status panel 302 may include information indicating an expected time at which the vehicle will arrive at the specified location. Status panel 302 may also include information identifying the vehicle scheduled to service the first user. For example, the information may include a license plate number (as illustrated) and other information identifying the vehicle, such as make, model, and color information.

Map panel 304 generally illustrates the route that the vehicle will take to satisfy the trip request generated by the first user. The route displayed in map panel 304 may be a route that includes one or more additional stops corresponding to trips requested by other users that are coordinated with the first user's trip. In some embodiments, map panel 304 may include additional information about the trip, such as an expected time at which the vehicle will arrive at the next stop on the trip and an expected time at which the vehicle will arrive at the first user's specified destination.

Request panel 306 generally provides information about requests that other users have made for the first user to satisfy during the first user's trip to the specified destination. As illustrated, the request panel 306 may provide information about the users that have requested that a first user perform a task and the requested task. In this example, three friends have made requests related to the first user's trip to the specified destination. As illustrated, user “xyzzy” has requested that the first user pick up specified items at “Food World”, user “waldo” has requested that the first user pick up his dry cleaning at a location near Food World, and user “fred” has requested a ride to “Food World” such that the vehicle serving the first user will also service user “fred”. Though not illustrated, it should be recognized that the first user can choose to accept or decline each request made by other users for the first user to satisfy using one or more user interface elements associated with each request. If the first user accepts a request, a notification may be generated to the other user associated with the request indicating that the request has been accepted. Otherwise, a notification may be generated indicating that the request has been declined, and the request may be coordinated with other trips requested through a vehicle scheduler.

Example Operations for Coordinating Trips By A Vehicle In An On Demand Environment For Multiple Users

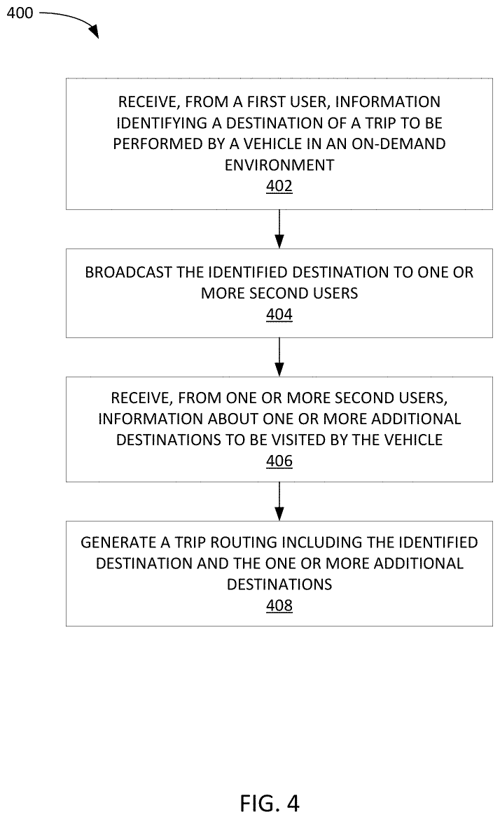

FIG. 4 illustrates example operations 400 that may be performed by a vehicle scheduler (e.g., vehicle scheduler 110 illustrated in FIG. 1, which may be a standalone component or integrated into an autonomous vehicle) to coordinate trips made by a first user using a vehicle in an on-demand environment with trips and/or tasks requested by other users.

As illustrated, operations 400 begin at block 402, where a vehicle scheduler receives, from a first user, information identifying a destination of a trip to be performed by an autonomous vehicle. The vehicle scheduler may receive this information from a mobile device or directly from data entry in the autonomous vehicle.

At block 404, the vehicle scheduler broadcasts the identified destination to one or more second users. In one embodiment, the one or more second users may be selected based on social network connections to the first user, proximity to the current location of the vehicle, proximity to a pickup location for the first user, proximity to the identified destination, or the like.

At block 406, the vehicle scheduler receives, from one or more second users, information about one or more destinations to be visited by the vehicle.

At block 408, the vehicle scheduler generates a trip routing including the identified destination and the one or more additional destinations. In some embodiments, the vehicle scheduler can generate the trip routing upon reaching a cutoff time for receiving requests from the one or more second users.

In some embodiments, the information about one or more additional destinations to be visited by the vehicle may include information about one or more tasks to be performed at the one or more additional destinations to be visited by the vehicle. The vehicle scheduler may adjust the identified destination to another destination based on the information about the one or more tasks to be performed at the one or more additional destinations such that at least a subset of the one or more tasks can be performed at a single destination. In some embodiments, the vehicle scheduler may prompt the first user to adjust the identified destination to the other destination. If the first user accepts the adjustment, the vehicle scheduler can recalculate a route for the trip using the other destination. Otherwise, the vehicle scheduler can generate a route including the destination identified by the first user and the one or more additional destinations.

In some embodiments, the identified destination may be broadcast to users within a geographic region based on one or more of a location of the first user or the identified destination.

In some embodiments, the identified destination may be broadcast to users within a threshold distance along a route from a current location of the first user to the identified destination.

In some embodiments, the vehicle scheduler can broadcast, to the one or more second users, a cutoff time with the identified destination. The trip routing may be generated upon reaching the cutoff time.

In some embodiments, the vehicle scheduler may retrieve, from a second vehicle in a network including the vehicle, destination information for a user of the second vehicle. The vehicle scheduler may receive the destination information directly from the second vehicle or from another vehicle scheduler. The vehicle scheduler can determine that the user of the second vehicle is traveling to a destination within a threshold distance from the identified destination of the trip. Based on the determination, the vehicle scheduler can display, to the first user, information about the second user. For example, the vehicle scheduler can display the information about the second user on a mobile device associated with the first user, on a display in the vehicle, or on other display devices visible to the first user.

In some embodiments, the second vehicle may include a vehicle that has arrived at the identified destination within a first threshold amount of time from a time at which the information identifying the destination of the trip to be performed by the autonomous vehicle as received from the first user, or a vehicle scheduled to reach the identified destination within a second threshold amount of time from a projected arrival time of the autonomous vehicle at the identified destination.

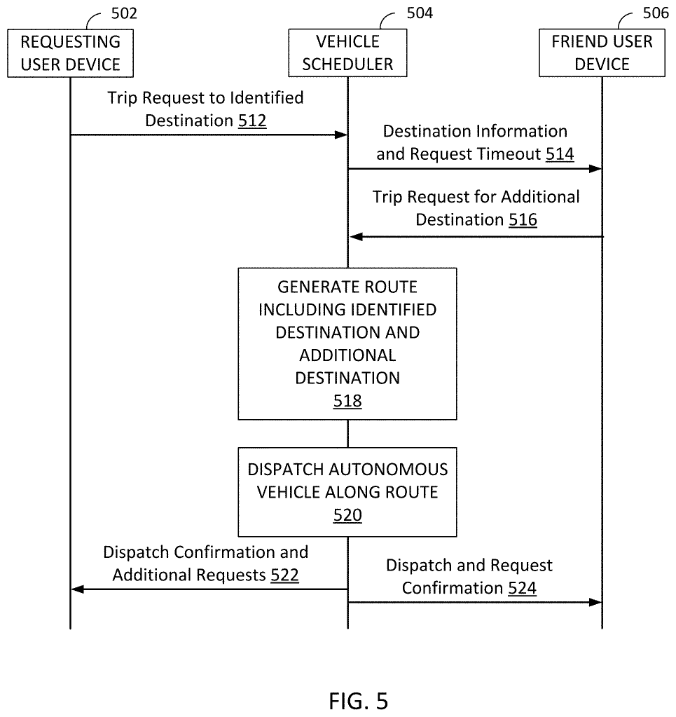

FIG. 5 illustrates a message flow diagram of messages that may be exchanged to coordinate a trip made by a first user of a vehicle in an on-demand environment with trips and tasks requested by other users. While FIG. 5 illustrates coordination of trips through a requesting user device 502 and a friend user device 506, it should be recognized that the messages generated in this example may be transmitted by vehicles in the on-demand environment themselves, and the information included in these messages may be entered into the vehicles by their respective users.

As illustrated, coordination of trips made by a first user and one or more other users using a vehicle in the on-demand environment may begin with a trip request to an identified destination 512 being received at a vehicle scheduler 504.

In response, vehicle scheduler 504 may transmit destination information and request timeout 514 to friend user device 506. The friend user device 506 may be selected based, for example, on a proximity of the friend user device 506 to the current location of the first user and/or the identified destination. The timeout period included in destination information and request timeout 514 may be based, for example, on a projected time at which a vehicle is scheduled to arrive at a current location of the first user, a projected time at which the vehicle is scheduled to arrive at the identified destination, or the like. In some embodiments, separate timeout periods may be established for a user of friend user device 506 to specify an additional destination to include in the trip and to specify one or more tasks for the first user to perform at the identified destination. For example, a user of friend user device 506 may be allowed to coordinate a trip to a different (or same) destination prior to a projected time at which the vehicle arrives at the current location of the user, and the user of friend user device 506 may be allowed to specify tasks to perform during the trip prior to a projected time at which the vehicle arrives at the identified destination.

Friend user device 506 may transmit trip request for additional destination 516 to vehicle scheduler 504 in response to receiving destination information and request timeout 514. At 518, the vehicle scheduler can generate a route including the identified destination and additional destination. Generally, the route may include a route from a current location of the vehicle selected to service the first user's trip request to a current location of the first user, and a route from the current location of the first user to the first user's destination and the additional destination specified in trip request 516. The vehicle selected by vehicle scheduler 504 may be, for example, the closest vehicle to the current location of the first user or other specified pickup location of the first user.

At 520, the vehicle scheduler dispatches the vehicle along the route generated at 518. Upon dispatching the vehicle, vehicle scheduler 504 transmits dispatch confirmation and additional requests 522 to the requesting user device 502 and a dispatch and request confirmation 524 to the friend user device 506.

Example Operations for Coordinating Trips By A Vehicle In An On Demand Environment For Multiple Users Based On Items to Retrieve During a Trip

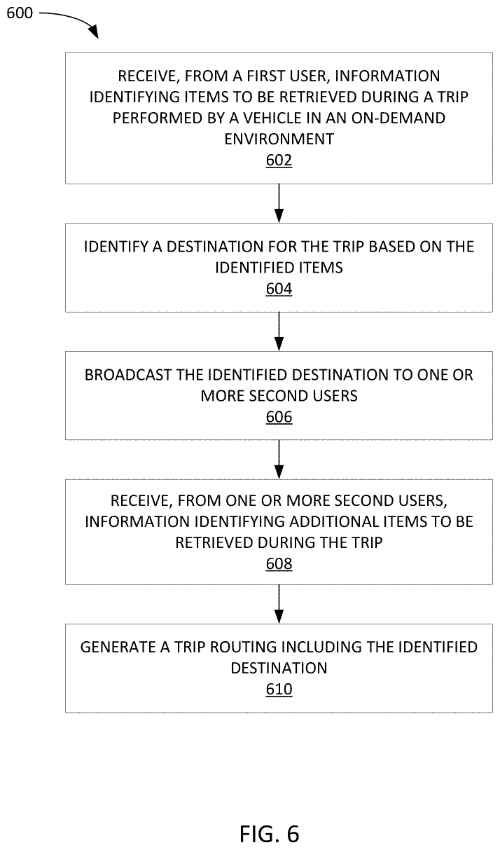

FIG. 6 illustrates example operations 600 that may be performed by a vehicle scheduler (e.g., vehicle scheduler 110 illustrated in FIG. 1, which may be a standalone component or integrated into an autonomous vehicle) for coordinating trips among multiple users of a vehicle in an on-demand environment based on items to retrieve during a trip.

As illustrated, operations 600 begin at block 602, where the vehicle scheduler receives, from a first user, information identifying items to be retrieved during a trip performed by a vehicle in the on-demand environment. The information may include, for example, general classes of items, specific items, and/or specific quantities of specific items.

At block 604, the vehicle scheduler identifies a destination for the trip based on the identified items. To identify the destination, the vehicle scheduler can use the identified items to identify one or more stores that are likely to carry the identified items. For example, if a user has submitted a list of food items to be retrieved during a trip, the vehicle scheduler can determine that the stores that are candidate destinations are grocery stores or hypermarkets that carry groceries; in another example, if a user has submitted a list of home improvement items to be retrieved during the trip, the vehicle scheduler can determine that the stores that are candidate destinations are home improvement stores. In some embodiments, the vehicle scheduler can search inventory management systems associated with each of the candidate stores to determine whether the requested items are in stock at a store and can select a subset of the candidate stores that have the requested items in stock. The selected destination may be a set of destinations selected to minimize a number of destinations visited by the first user and/or a distance traversed by the vehicle.

At block 606, the vehicle scheduler broadcasts the identified destination to one or more second users. As discussed, the one or more second users may be selected based on social network connections to the first user, proximity to the current location of the vehicle, proximity to a pickup location for the first user, proximity to the identified destination, or the like. The broadcast may further include a cutoff time, which identifies a deadline for the user to submit requests for coordination and consolidation with the first user's trip.

At block 608, the vehicle scheduler receives, from one or more second users, information identifying additional items to be retrieved during the trip.

At block 610, the vehicle scheduler generates a trip routing including the identified destination. In some embodiments, the vehicle scheduler can generate the trip routing upon reaching a cutoff time for receiving requests from the one or more second users. In some embodiments, the vehicle scheduler may analyze the information identifying the additional items to be retrieved during the trip to modify the identified destination and/or add destinations to the trip routing.

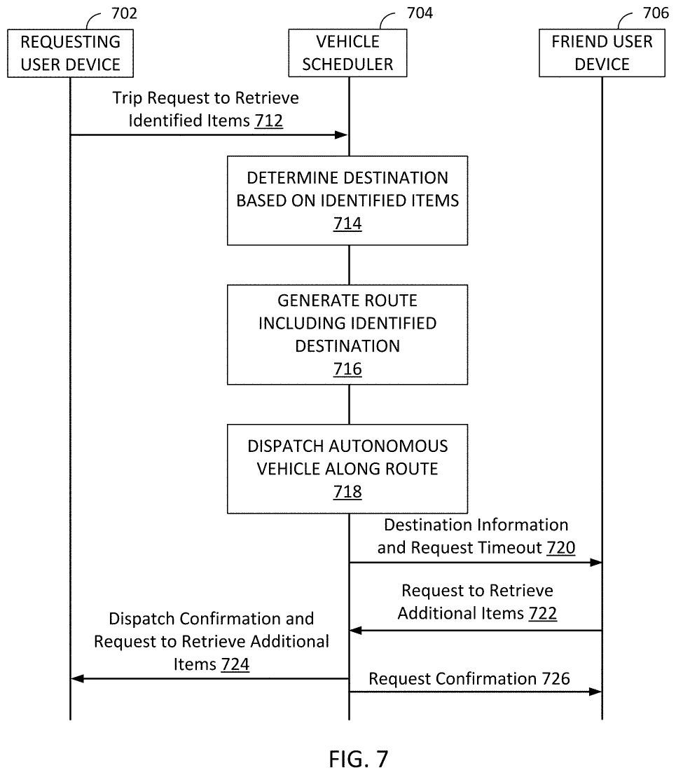

FIG. 7 illustrates a message flow diagram of messages that may be exchanged to coordinate a trip made by a first user of a vehicle in an on-demand environment with trips and tasks requested by other users. While FIG. 7 illustrates coordination of trips through a requesting user device 702 and a friend user device 706, it should be recognized that the messages generated in this example may be transmitted by vehicles themselves, and the information included in these messages may be entered into the vehicles.

As illustrated, coordination of trips made by a first user and one or more other users may begin with a trip request for identified items 712 being transmitted from a requesting user device 702 to a vehicle scheduler 704.

At block 714, the vehicle scheduler determines a destination based on the identified items in the trip request 712. As discussed, the scheduler can determine the destination for the first user to minimize the number of stores the user needs to visit to retrieve the identified items. The vehicle scheduler can identify stores within a threshold distance of the current location of the user or some other specified location and select a set of candidate stores as the stores that are likely to carry the identified items. In some embodiments, the vehicle scheduler 704 can retrieve inventory information from each of the candidate stores to identify a minimal set of stores to visit in order for the first user to retrieve the identified items.

At block 716, the system generates a route including the identified destination. To generate a route, the system can identify a vehicle in a fleet of vehicles in the on-demand environment to use to service the first user's request and generate a route from the current location of the identified vehicle to the current location of the first user, and then to the identified destination. The vehicle selected by vehicle scheduler 704 may be, for example, the closest vehicle to the current location of the first user or other specified pickup location of the first user.

At block 718, the system dispatches the vehicle along the generated route. Upon dispatching the vehicle, vehicle scheduler 704 transmits destination information and request timeout 720 to a friend user device 706. The friend user device 706 may allow a user to request that the first user retrieve additional items until the request timeout period expires.

Friend user device 706 transmits a request to retrieve additional items 722 to vehicle scheduler 704. Vehicle scheduler 704 can consolidate the items identified in request 712 with the additional items in request 722 to generate a consolidated list of items for the first user to retrieve. Vehicle scheduler 704 can then transmit dispatch confirmation and request to retrieve the additional items 724 to requesting user device 702 to inform the first user that another user has requested that the first user pick up the additional items. Vehicle scheduler 704 may also transmit a request confirmation 726 to friend user device 706 indicating that the additional items have been added to the first user's list of items to retrieve from at the identified destination.

Example Operations for Identifying Users At A Destination Based On An Identified Destination Of A Vehicle In An On-Demand Environment

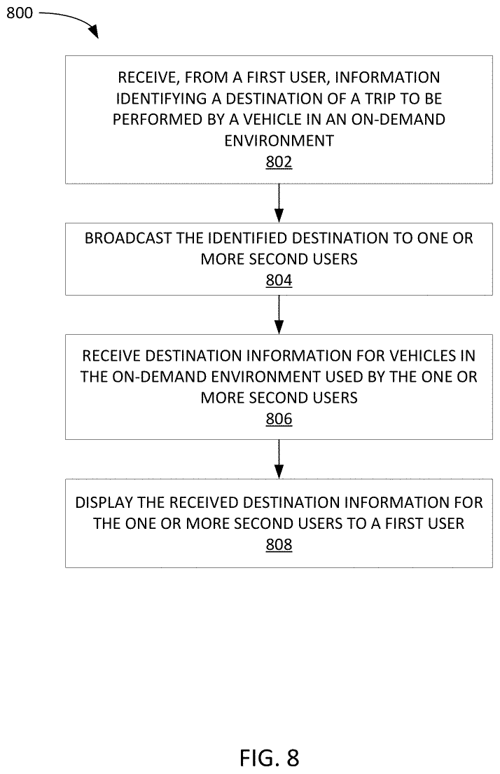

FIG. 8 illustrates example operations 800 that may be performed by a vehicle (e.g., vehicle 120 illustrated in FIG. 1, which may include a vehicle scheduler) to identify users of vehicles in an on-demand environment based on a destination of an autonomous vehicle for a first user.

As illustrated, operations 800 begin at block 802, where a vehicle receives, from a first user, information identifying a destination of a trip to be performed by the autonomous vehicle.

At block 804, the vehicle broadcasts the identified destination to one or more second users. The one or more second users may be, for example, users of other autonomous vehicles in a fleet of autonomous vehicles.

At block 806, the vehicle receives destination information from vehicles used by the one or more second users. The destination information may identify the location to which a vehicle is en route or the location of a most recently completed trip (e.g., if the vehicle has completed a trip within a threshold amount of time from receiving the broadcasted identified destination of the first user) and the time at which the trip was completed.

At block 808, the vehicle displays the received destination information for the one or more second users to a first user. The destination information may be displayed on a screen in the vehicle or on a screen of a mobile device used by a first user to summon and schedule trips by the vehicle. In some embodiments, the destination information for the one or more second users may exclude users that are likely to be leaving from their current locations prior to or within a threshold amount of time after the first user is projected to arrive at the identified destination. The one or more second users may, for example, be grouped such that users at the same location are displayed together, which may allow a user to quickly identify which locations may be of interest and, in some cases, change a destination of the vehicle.

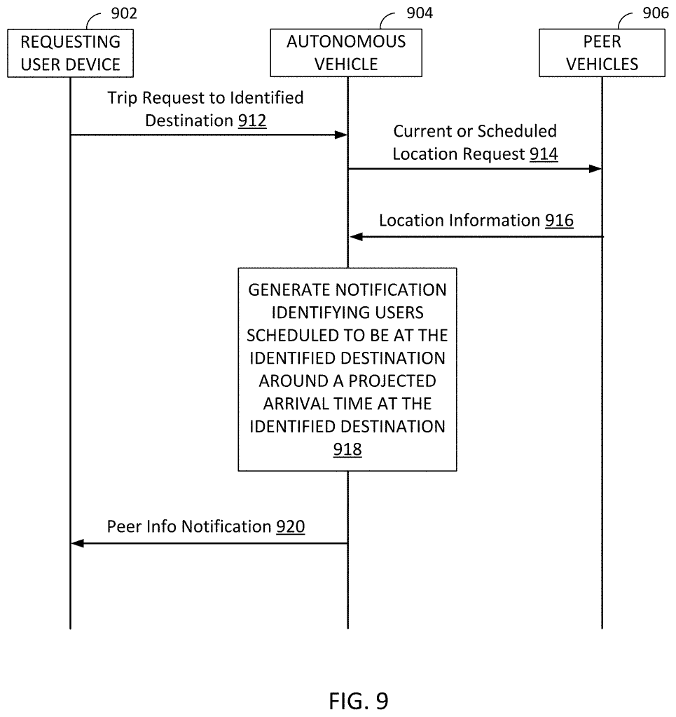

FIG. 9 illustrates a message flow diagram of messages that may be exchanged to identify users of vehicles based on a destination of a vehicle in a fleet of vehicles in an on-demand environment for a first user. While FIG. 9 illustrates the identification of users through an autonomous vehicle 904, it should be recognized that the identification of users may be performed by a vehicle scheduler that operates independently of the autonomous vehicle 904 and peer vehicles 906. It should further be recognized that while FIG. 9 refers to autonomous vehicles, similar tasks may be performed by human-controlled vehicles capable of broadcasting and receiving location information from peer vehicles directly or indirectly.

As illustrated, identification of user of vehicles based on the destination of a vehicle for a first user may begin with a trip request to an identified destination 912 being received from a requesting user device 902 to an autonomous vehicle 904. As discussed, the requesting user device 902 may be a mobile device (e.g., a mobile phone) used by the first user to request a trip using an autonomous vehicle or may be integral to autonomous vehicle 904.

Autonomous vehicle may transmit current or scheduled location request 914 to one or more peer vehicles 906 (e.g., in a broadcast message). The current or scheduled location request 914 may explicitly include a request for location information from the peer vehicles or may be implicitly treated as a request by the peer vehicles 906 (e.g., where current or scheduled location request 914 includes the identified destination from request 912).

In response to receiving current or scheduled location request 914, the peer vehicles 906 may transmit location information 916, which includes the scheduled destination for an autonomous vehicle (e.g., if the peer vehicle 906 is en route to a destination), the current destination of an autonomous vehicle (e.g., if the peer vehicle 906 has completed a trip and is waiting for a request to service another user), or the previous destination of the autonomous vehicle (e.g., if the peer vehicle 906 has accepted a request to service another user but has not reached the other user).

At block 918, the autonomous vehicle 904 generates a notification identifying users scheduled to be at the identified destination around a projected arrival time at the identified destination. The identified users may include users who are en route to the identified destination (or a destination within a threshold distance from the identified destination) who are projected to arrive within a threshold amount of time prior to the projected arrival time or a threshold amount of time after the projected arrival time. In some embodiments, the identified users may exclude users who are currently at the identified destination and arrived at the identified destination more than a threshold amount of time prior to the projected arrival time.

At block 920, the autonomous vehicle generates a peer information notification 922 and transmits the notification for display on the requesting user device 902.

Example Vehicle Systems for Coordinating Trips For Multiple Users Of A Vehicle In An On-Demand Environment

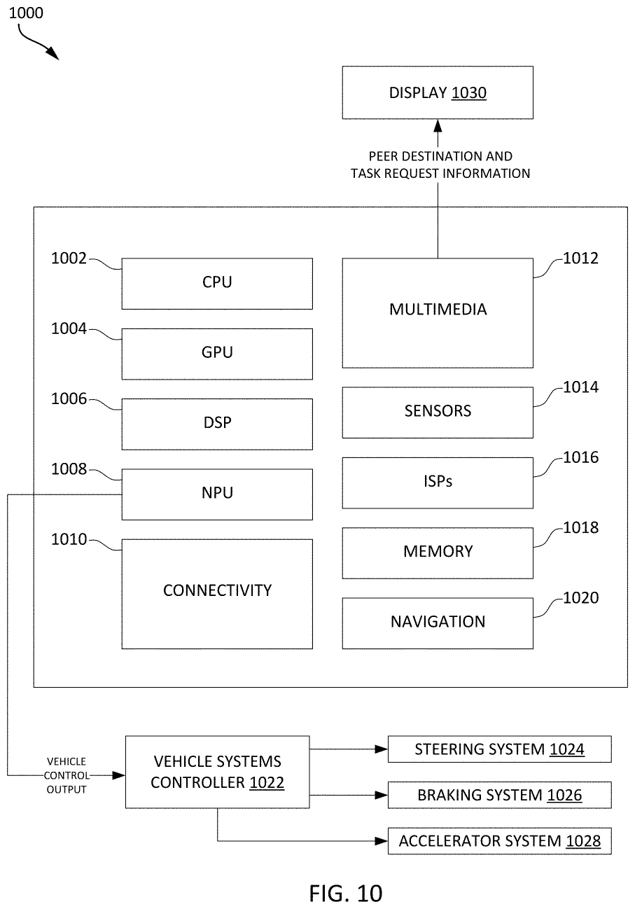

FIG. 10 illustrates an example implementation of an autonomous vehicle system 1000, which may include a central processing unit (CPU) 1002 or a multi-core CPU configured to control an autonomous vehicle and coordinate trips for multiple users of an autonomous vehicle, according to embodiments described herein. Neural networks and other parameters used to control an autonomous vehicle may be stored in a memory block associated with a neural processing unit (NPU) 1008, in a memory block associated with a CPU 1002, in a memory block associated with a graphics processing unit (GPU) 1004, in a memory block associated with a digital signal processor (DSP) 1006, in a memory block 1018, or may be distributed across multiple blocks. Instructions executed at the CPU 1002 may be loaded from a program memory associated with the CPU 1002 or may be loaded from a memory block 1018.

The autonomous vehicle system 1000 may also include additional processing blocks tailored to specific functions, such as a GPU 1004, a DSP 1006, a connectivity block 1010, which may include fifth generation (5G) connectivity, fourth generation long term evolution (4G LTE) connectivity, Wi-Fi connectivity, USB connectivity, Bluetooth connectivity, and the like, and a multimedia processor 1012 that may, for example, detect and recognize gestures. The autonomous vehicle system 1000 may also include a sensor processor 1014, image signal processors (ISPs) 1016, and/or navigation module 1020, which may include a global positioning system.

The CPU 1002 in autonomous vehicle system 1000 may be based on an ARM instruction set. In an aspect of the present disclosure, the instructions loaded into the CPU 1002 may comprise code to operate an autonomous vehicle and coordinate trips for multiple users of the autonomous vehicle.

Autonomous vehicle system 1000 and/or components thereof may be configured to perform the methods described herein.

Generally, to control an autonomous vehicle, CPU 1002, GPU 1004, DSP 1006, and/or NPU 1008 can use information obtained from one or more sensors 1014 and navigation 1020 to generate vehicle control output that controls the speed and direction of travel for an autonomous vehicle. The information from sensors 1014 may include, for example, distance information for vehicles around the autonomous vehicle, images captured by one or more cameras (e.g., for collision detection and avoidance), and other information. Generally, based on the information from sensors 1014, NPU 1008 can generate a vehicle control output that includes instructions for controlling one or more vehicle subsystems and transmit the vehicle control output to vehicle systems controller 1022. Vehicle systems controller 1022 can use this information to transmit control information to one or more of steering system 1024 (e.g., to control steering inputs and adjust a direction in which the autonomous vehicle is traveling), braking system 1026, and accelerator system 1028.

Multimedia 1012 may be communicatively coupled with a display 1030. Display 1030 may display one or more graphical user interfaces that includes information about the destination of the autonomous vehicle, peer destination requests that have been coordinated with a trip request generated by a first user, and/or task request information from other users who have requested coordination of tasks at the identified destination of the first user's trip request.

Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for coordinating trips for multiple users in an autonomous vehicle system, comprising:
receiving, from a first user, information identifying a destination of a trip to be performed by an autonomous vehicle;
broadcasting the identified destination to one or more second users;
receiving, from the one or more second users, information about one or more additional destinations to be visited by the autonomous vehicle; and
generating a trip routing including the identified destination and the one or more additional destinations.

2. The method of claim 1, wherein the information about one or more additional destinations to be visited by the autonomous vehicle comprises: information about one or more tasks to be performed at the one or more additional destinations to be visited by the autonomous vehicle.

3. The method of claim 2, further comprising: adjusting the identified destination to another destination based on the information about the one or more tasks to be performed at the one or more additional destinations such that at least a subset of the one or more tasks can be performed at a single destination.

4. The method of claim 1, wherein broadcasting the identified destination to one or more second users comprises broadcasting the identified destination to users connected with the first user on one or more social networks.

5. The method of claim 1, wherein broadcasting the identified destination to one or more second users comprises broadcasting the identified destination to users within a geographic region based on one or more of a location of the first user or the identified destination.

6. The method of claim 1, broadcasting the identified destination to one or more second users comprises broadcasting the identified destination to users within a threshold distance along a route from a current location of the first user to the identified destination.

7. The method of claim 1, wherein broadcasting the identified destination to the one or more second users comprises broadcasting a cutoff time, and wherein the trip routing is generated upon reaching the cutoff time.

8. The method of claim 1, further comprising:
retrieving, from a second autonomous vehicle in a network including the autonomous vehicle, destination information for a user of the second autonomous vehicle;
determining that the user of the second autonomous vehicle is traveling to a destination within a threshold distance from the identified destination of the trip; and
displaying, to the first user, information about the second user.

9. The method of claim 8, wherein the second autonomous vehicle comprises:
an autonomous vehicle that has arrived at the identified destination within a first threshold amount of time from a time at which the information identifying the destination of the trip to be performed by the autonomous vehicle as received from the first user, or
an autonomous vehicle scheduled to reach the identified destination within a second threshold amount of time from a projected arrival time of the autonomous vehicle at the identified destination.

10. A system, comprising:
a processor; and
a memory having instructions stored thereon which, when executed by the processor, performs an operation for coordinating trips for multiple users in an autonomous vehicle system, the operation comprising:
receiving, from a first user, information identifying a destination of a trip to be performed by an autonomous vehicle,
broadcasting the identified destination to one or more second users,
receiving, from the one or more second users, information about one or more additional destinations to be visited by the autonomous vehicle, and
generating a trip routing including the identified destination and the one or more additional destinations.

11. The system of claim 10, wherein the information about one or more additional destinations to be visited by the autonomous vehicle comprises: information about one or more tasks to be performed at the one or more additional destinations to be visited by the autonomous vehicle.

12. The system of claim 11, wherein the operation further comprises: adjusting the identified destination to another destination based on the information about the one or more tasks to be performed at the one or more additional destinations such that at least a subset of the one or more tasks can be performed at a single destination.

13. The system of claim 10, wherein broadcasting the identified destination to one or more second users comprises broadcasting the identified destination to users connected with the first user on one or more social networks.

14. The system of claim 10, wherein broadcasting the identified destination to one or more second users comprises broadcasting the identified destination to users within a geographic region based on one or more of a location of the first user or the identified destination.

15. The system of claim 10, broadcasting the identified destination to one or more second users comprises broadcasting the identified destination to users within a threshold distance along a route from a current location of the first user to the identified destination.

16. The system of claim 10, wherein broadcasting the identified destination to the one or more second users comprises broadcasting a cutoff time, and wherein the trip routing is generated upon reaching the cutoff time.

17. The system of claim 10, wherein the operation further comprises:
retrieving, from a second autonomous vehicle in a network including the autonomous vehicle, destination information for a user of the second autonomous vehicle;
determining that the user of the second autonomous vehicle is traveling to a destination within a threshold distance from the identified destination of the trip; and
displaying, to the first user, information about the second user.

18. The system of claim 17, wherein the second autonomous vehicle comprises:
an autonomous vehicle that has arrived at the identified destination within a first threshold amount of time from a time at which the information identifying the destination of the trip to be performed by the autonomous vehicle as received from the first user, or
an autonomous vehicle scheduled to reach the identified destination within a second threshold amount of time from a projected arrival time of the autonomous vehicle at the identified destination.

19. A computer-readable medium having instructions stored thereon which, when executed by a processor, perform an operation for coordinating trips for multiple users in an autonomous vehicle system, comprising:
receiving, from a first user, information identifying a destination of a trip to be performed by an autonomous vehicle;
broadcasting the identified destination to one or more second users;
receiving, from the one or more second users, information about one or more additional destinations to be visited by the autonomous vehicle; and
generating a trip routing including the identified destination and the one or more additional destinations.

20. The computer-readable medium of claim 19, wherein the operation further comprises:
retrieving, from a second autonomous vehicle in a network including the autonomous vehicle, destination information for a user of the second autonomous vehicle;
determining that the user of the second autonomous vehicle is traveling to a destination within a threshold distance from the identified destination of the trip; and
displaying, to the first user, information about the second user,
wherein the second autonomous vehicle comprises an autonomous vehicle that has arrived at the identified destination within a first threshold amount of time from a time at which the information identifying the destination of the trip to be performed by the autonomous vehicle as received from the first user, or an autonomous vehicle scheduled to reach the identified destination within a second threshold amount of time from a projected arrival time of the autonomous vehicle at the identified destination.
